(19) United States
(12) Patent Application Publication
(10) Pub. No.: US 2003/0183994 A1
(43) Pub. Date: Oct. 2, 2003

(54) Damper spring strut

(76) Inventor: D. Stuart Atwater, Grand Rapids, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/396,850

(22) Filed: Mar. 25, 2003

Related U.S. Application Data
(60) Provisional application No. 60/367,855, filed on Mar. 27, 2002.

(51) Int. Cl. F16F 9/00

(52) U.S. Cl. 267/71

(57) ABSTRACT

A damper spring strut has a cylindrical steel tube with a polymeric spool mounted therein for supporting an annular foam polymeric friction element which is coupled to a support rod. A compression spring extends between an end block of the cylinder to bias the spool toward one end of the cylinder. The support rod coupled to the spool extends through an aperture in an end cap of the cylinder for attachment to an object to be supported, such as a washer drum.

### CROSS-REFERENCE TO RELATED APPLICATIONS

This application claims priority under 35 U.S.C. § 119(e) on U.S. Provisional Application No. 60/367,855 entitled DAMPER SPRING STRUT, filed on Mar. 27, 2002, by D. Stewart Atwater, the entire disclosure of which is incorporated herein by reference.

### BACKGROUND OF THE INVENTION

The present invention relates to a damper spring strut which can be used in tension for supporting and suspending relatively heavy objects, such as washing machine drums.

There have been a variety of spring struts employed for suspending washing machine drums which can either extend between the drum and base to support the weight of the drum in a support strut compensation configuration or can be designed to allow the drum to hang in tension from the top wall of the washer. Most of the struts are cylindrical shock-absorbing type structures with friction pads which ride either on the central rod of the damper or in some cases on the inner cylindrical surface of the damper housing. Some designs employ attachment rods which are coated with a lubricant, such as grease, which is exposed during use and can become contaminated with dust and, therefore, can wear the damper mechanism excessively during extended use. When suspending or supporting washing machine drums, it is necessary to have a relatively robust spring damper mechanism which can withstand the variable forces presented during a washing cycle, including rinse and spin dry cycles, of a washing machine tub. It is also desirable that such struts have a relatively long life and yet be relatively inexpensive.

One of the factors that tends to minimize the life of existing damper springs is the frictional heat caused by the engagement of the friction element of the damper mechanism which tends to wear excessively due to overheating. Thus, there remains a need for a damper spring mechanism which overcomes the difficulties of existing dampers and provides a structure which can be employed as a tension strut for various mounting configurations of objects such as washing machine tubs.

### SUMMARY OF THE INVENTION

The damper spring assembly of the present invention satisfies this need by providing a cylindrical steel tube having a polymeric spool mounted therein for supporting an annular foam polymeric friction element which is coupled to a support. A compression spring extends between an end block of the cylinder to bias the spool toward one end of the cylinder. The rod coupled to this spool extends through an aperture in an end cap of the cylinder for attachment to an object to be supported, such as a washer drum. A temperature stable lubricant surrounds the friction element and is sealed within the cylindrical housing of the damper spring to provide the desired damping of the piston defined by the spool and friction element within the cylindrical housing. The damper spring can be employed as a hanger in a variety of mounting arrangements.

These and other features, objects and advantages of the present invention will become apparent upon reading the following description thereof together with reference to the accompanying drawings.

### BRIEF DESCRIPTION OF THE DRAWINGS

FIG. 1 is a side elevational schematic view of a structure, such as a washing machine, employing a pair of prior art damper spring struts;

FIG. 2 is a rear elevational view of the machine shown in FIG. 1;

FIG. 3 is an enlarged vertical cross-sectional view of a prior art compression damper spring strut shown in FIGS. 1 and 2;

FIG. 4 is an enlarged vertical cross-sectional view of the damper spring strut of the present invention;

FIG. 5 is a schematic view of a mounting system for a structure, such as a washer tub, using damper spring struts as shown in FIG. 4;

FIG. 6 is a schematic perspective view of yet another alternative mounting system for a structure, such as a washer tub, employing damper spring struts embodying the present invention as shown in FIG. 4;

FIG. 7 illustrates a mounting system for a structure, such as a vertically mounted washer tub, employing four damper springs of the type shown in FIG. 4; and

FIG. 8 is an enlarged vertical cross-sectional view of yet another embodiment of the present invention which can be employed for supporting a structure, such as a top loading type washer tub.

### DETAILED DESCRIPTION OF THE PREFERRED EMBODIMENT

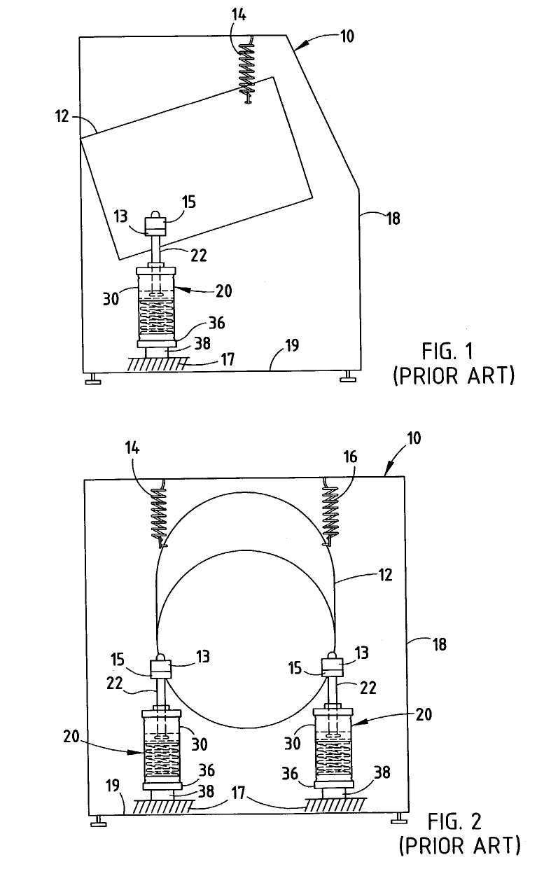

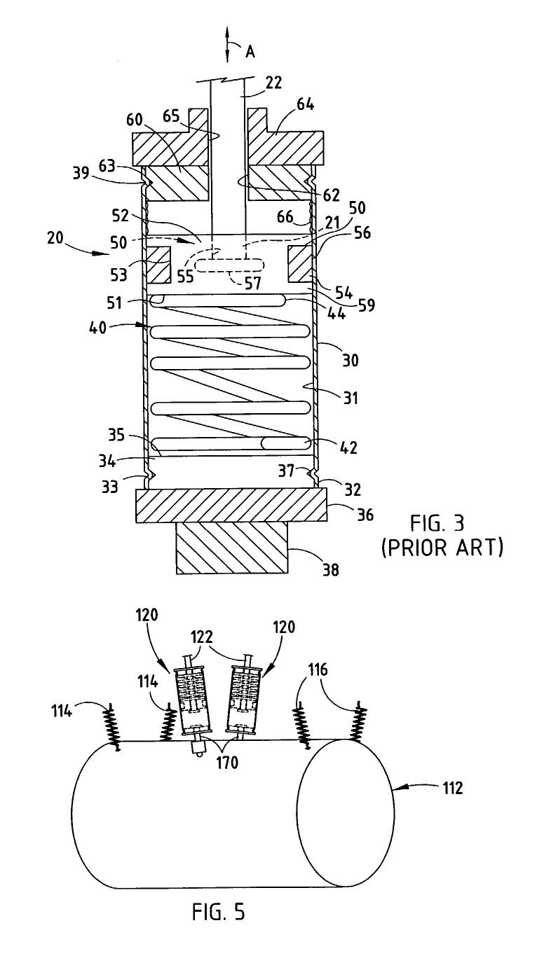

Referring initially to FIGS. 1-3, there is shown a structure to be mounted in a housing employing the compression struts of the prior art. The structure comprises a washing machine 10 which includes an outer cylindrical tub 12 which, in turn, supports, as is well-known, an inner rotating tub for receiving clothing to be washed. The outer tub 12 must accommodate the unbalanced forces encountered when clothing is being washed and during spin dry cycles which frequently, due to unbalances of clothing loads and the weight involved with wet clothing, can be significant. As a result, tub 12 is suspended by a variety of mounting arrangements, typically including, as shown in FIGS. 1 and 2, at least a pair of tension springs 14 and 16 and a pair of compression damper spring struts 20, which can be of the type shown in FIG. 3. The damper spring struts 20 each include a movable rod 22 which, as seen in FIGS. 1 and 2, is coupled by rubber bushings 13 to a mounting flange 15 on tub 12. Struts 20 thus serve to control the motion of tub 12 when undergoing the vibrational forces during washing cycles of the machine 10.

Damper spring strut 20, as seen in FIG. 3, includes a cylindrical steel housing 30. In FIG. 3, the lower end 32 of cylinder 30 is roll-crimped at 33 to sealably engage an annular recess 37 in an end cap 34 to which a support block 36 is attached. Block 36, in turn, is engaged by a rubber bushing 38 which is adhesively attached to block 36 and to a support 17, as seen in FIGS. 1 and 2, of the floor 19 of cabinet 18 of washer 10. End cap 34 and block 36 are made of a polymeric material, such as polyethylene. As shown in FIG. 3, roll-formed projection 33 extends into annular recess 37 to seal the lower end 32 of cylinder 30 to cap 34.

A compression spring 40 has a lower end 42 which engages the upper surface 35 of end cap 34 and an upper end 44 which engages the lower surface 51 of piston assembly 50 which includes a polymeric spool 52 with an annular recess 53 receiving an annular friction element 54. The recess 53 in spool 52 is defined by an upper circular flange 58 and a spaced-apart lower circular flange 59. The flanges 58 and 59 are spaced apart a distance sufficient to accommodate friction element 54, as illustrated in FIG. 3. The annular recess 53 of spool 52 captively holds the annular friction element 54 which can be a closed-cell foam polyurethane.

The external cylindrical surface 56 of friction element 54 and/or the inner cylindrical surface 31 of cylinder 30 is liberally coated with a commercially available highly temperature stable lubricant 66 to provide the desired frictional characteristics between element 54 and cylinder 30 for the damper spring strut 20.

Rod 22 is coupled to piston assembly 50 by providing a threaded end 21 to rod 22 which fits within a threaded aperture 55 in spool 52. The spool is made of a suitable polymeric material, such as polyethylene, and can be molded onto a flared end 57 of the rod as an integral structure. Rod 22 extends through an aperture 62 in an upper end cap 60, which is generally spool-shaped having an annular recess 63 for receiving a roll-crimp 39 on the upper end of cylindrical housing 30. A mounting bushing 64 is coupled to upper end cap 60 and provides additional lateral support for rod 22 through aperture 65 in bushing 64. With this configuration, rod 22 can move upwardly and downwardly in the direction indicated by arrow A to withstand the compressive forces placed upon it by tub 12 and dampen the motion of the tub during washing, rinsing, and spinning cycles of the washing machine 10.

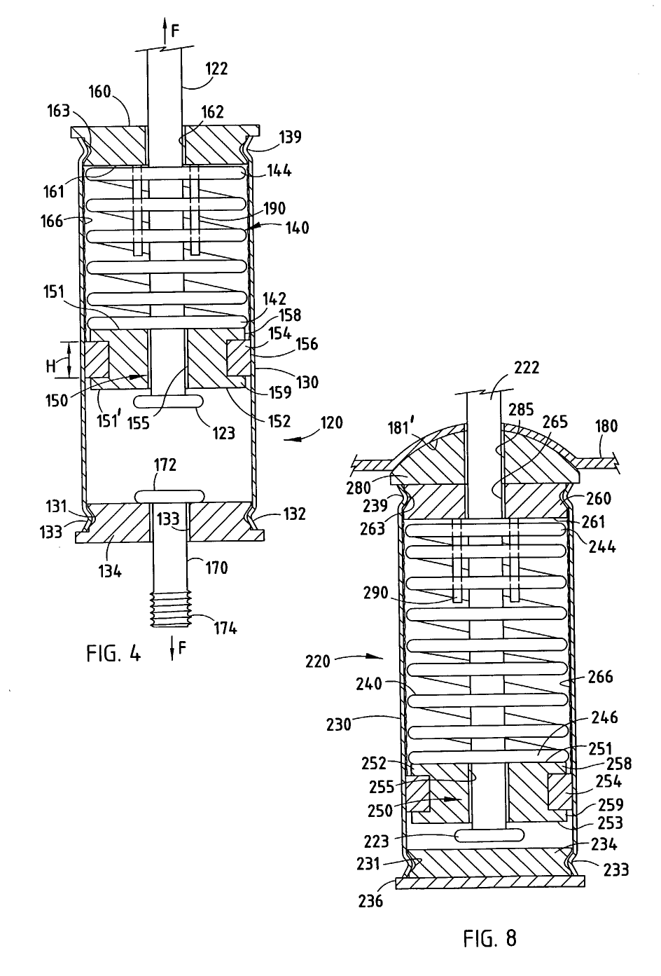

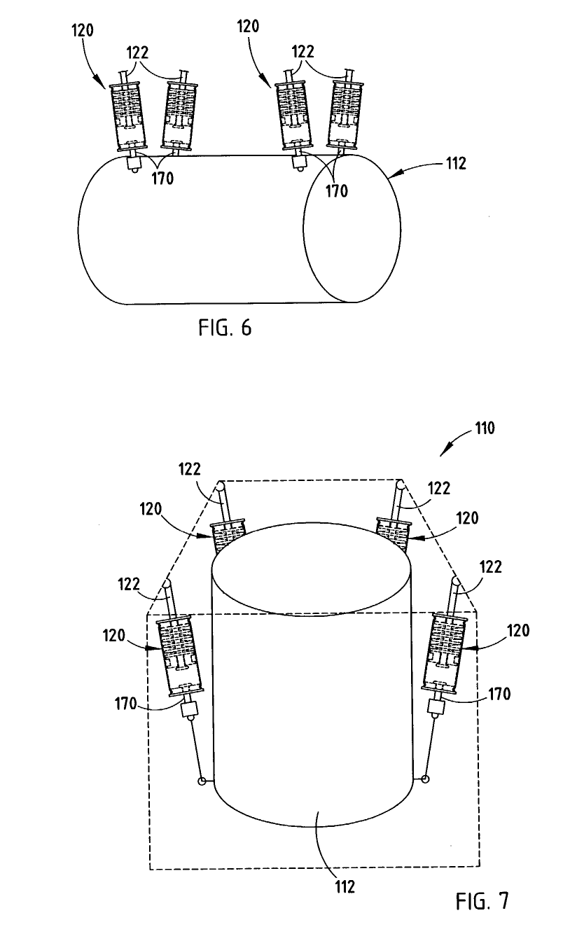

FIGS. 5 and 6 shown alternative mounting systems for a washer drum 112, which is a front-loading type drum in which they are suspended from the upper structure of a washer cabinet as opposed to being supported from both the top and bottom. In a system such as shown in FIG. 5, drum 112 is mounted by front and rear pairs of tension springs 114 and 116 and a pair of dampers 120 embodying the present invention. Dampers 120 have one end coupled to the drum 112 and an opposite end coupled in a conventional manner, such as by threaded fasteners, to the top wall of a washer cabinet. In FIG. 6, four damper springs 120 are employed for mounting the drum 112 to the washer cabinet. Thus, in each of these mounting systems, a hanger or tension-type damper is employed as opposed to a compression-type damper as shown in FIG. 3. One embodiment of a tension damper of the present invention is shown in FIG. 4.

In FIG. 4, a rod 122 extends through an aperture 162 in an upper end cap 160, which has an annular outer recess 163 which receives the crimped upper end 139 of the steel cylinder 130 of the damper 120 shown therein. In one embodiment, cylinder 130 had an outer diameter of 32 millimeters (mm), an inner diameter of 28 mm, and an overall length of from about 60 mm to about 300 mm depending on the particular application. A compression spring 140 extends between the lower surface 161 of upper end cap 160 and the upper surface 151 of piston assembly 150. Spring 140, in the preferred embodiment of the invention, had an outer diameter of approximately 27 mm and was approximately 60 mm in length with the spring constant “k” of 4N/mm. Piston assembly 150 includes a polymeric spool 152 for receiving annular friction element 154 having a height “H” in FIG. 3 of about 6 mm to about 40 mm, depending upon the application, and a thickness of about 30 mm when uncompressed prior to fitting within the cylinder. Rod 122 extends through a central aperture 155 in spool 152, and the end of rod 122 is flattened at 123 to engage the lower surface 151′ of spool 152 for supporting the rod 122 when spring 140 is under compression by the attachment of cylinder 120 at its lower end 132 to a frame by the use of a threaded fastener 170 extending through an aperture 133 in end block 134. Block 134 includes an annular recess 131 receiving a roll-crimped inwardly projecting member 135 at the lower end of cylinder 130 for attaching the polymeric end cap 134 therein. Threaded member 170 includes a flattened upper end 172 and a threaded lower end 174 which is conventionally secured to a mounting flange on drums 112 in the configuration shown in FIGS. 5 and 6, such that the forces of the weight of the drums 112, indicated by arrows “F” in FIG. 4, tend to compress spring 140 during motion of the drums 112. Lubricant 166 lines the inner wall of cylinder 130 and is a commercially available highly temperature stable lubricant.

The relatively large height “H” of friction element 154, together with the thermal characteristics of the steel cylinder 130, provides excellent heat dissipation, thereby leading to a longer life for the strut. The design of the damper spring 120 also maintains the lubricant in a sealed environment against contamination due to dust and the like in the harsh environment of structures, such as washing machine 110. The damper strut 120 may include an annular stop 190 which extends downwardly from the lower surface of upper end cap 160 positioned in the annular space between rod 122 and spring 140 to prevent the bottoming out of spring 140 in violent loading conditions. Stop 190 can be free-floating, if desired, along rod 122 or integrally formed with upper end cap 160. Stop 190 can be molded of a suitable polymeric material, such as polyethylene or the like, and can be integrally molded with end cap 160.

Damper spring struts 120 can also be employed for use in connection with a vertically mounted top-loading washing machine 110, as seen in the schematic view of FIG. 7, which includes a drum 112 mounted by four dampers 120 which each include a lower rod 170 attached to the lower end of the drum 112 and upper rods 122 attached to the upper wall of machine 110. Thus, damper springs 120 can be employed with any configuration of a suspended structure, such as a washing machine, including front-load, top-load, or diagonally mounted loading washing machines.

An alternative embodiment of the damper is shown in FIG. 8, which is particularly suitable for the extension mounting of a washer tub in which a bracket 180 extends from the side wall of the washing machine drum and engages an upper hemispherical cap 280 of spring damper 220. In damper 220, an upper end cap 260 is spool-shaped and includes an annular recess 263 which receives a roll-crimp 239 on the upper end of cylinder 230 to seal the upper end cap to the cylinder. Tension rod 222 extends through an aperture 265 in end cap 260. A domed hemispherical reaction cap 280 is coupled to the upper end of end cap 260 and includes an aperture 285 through which rod 222 extends. Cap 280 receives the hemispherical socket of 181 of bracket 180 and is held in place therein allowing some rotational movement between member 280 and surface 181′ of bracket 180 for the hanging mounting of the washer drum, such as shown in the embodiments of FIGS. 5 and 6. Member 280 can, in some embodiments, be integrally molded with cap 260 of a suitable polymeric material, such as polyethylene or the like, if desired. Compression spring 240 extends between the lower surface 261 of end cap 260 and the upper surface 251 of piston assembly 250 which includes spool 252 having an annular recess for receiving an annular friction element 254 of the same material and dimensions as employed in the embodiment of FIG. 4 and described above.

Rod 222 extends through an aperture 255 in spool 252 and includes a flattened end 223, which engages the lower surface 253 of spool 252. The lower end of cylinder 230 is sealed by a lower end cap 234 which may include a base plate 236, which can be integral with end cap 234. Cap 234 includes an annular recess 231 which receives a roll-formed crimp 233 at a lower end of cylinder 230. The damper strut 220 may include an annular stop 290 which extends downwardly from the lower surface of upper end cap 260 positioned in the annular space between rod 222 and spring 240 to prevent the bottoming out of spring 240 in violent loading conditions. Stop 290 can be free-floating, if desired, along rod 222 or integrally formed with upper end cap 260. Stop 290 can be molded of a suitable polymeric material, such as polyethylene or the like, and can be integrally molded with end cap 260.

With each of the embodiments, therefore, an external, relatively large steel cylinder provides excellent heat dissipation for the frictional engagement of a spool-shaped piston having an enlarged friction element and provides a sealed environment for the lubrication for the friction element. As a result, a relatively durable and less costly damper spring is provided with the dampers of the present invention.

It will become apparent to those skilled in the art that various modifications to the preferred embodiment of the invention as described herein can be made without departing from the spirit or scope of the invention as defined by the appended claims.

The invention claimed is:

1. A damper spring strut comprising:
a cylindrical housing having an inner cylindrical surface;
an upper end cap sealing one end of said housing;
a compression spring having an upper end engaging said end cap and a lower end;
a piston assembly including a spool and annular friction element positioned on said spool and within said cylinder, said spool having an upper surface engaging said lower end of said compression spring;
a piston rod mounted to said spool and extending from said spool through said compression spring; and
a lower end cap enclosing a lower end of said cylindrical housing, and wherein said upper end cap includes an aperture through which said rod extends, such that said rod can be coupled to a support member.

2. The strut as defined in claim 1 and further including a cylindrical spring stop surrounding said rod and extending into the annular space between said rod and said compression spring.

3. The strut as defined in claim 1 and further including a lubricant extending between said friction element and said inner surface of said cylindrical housing.

4. The strut as defined in claim 3 wherein said spool is made of a polymeric material.

5. The strut as defined in claim 4 wherein said friction element is made from a closed-cell foam polymeric material.

6. The strut as defined in claim 5 wherein said foam polymeric material is polyurethane.

7. The strut as defined in claim 6 wherein said cylindrical housing is made of steel.

8. The strut as defined in claim 7 wherein said friction element has a height of from about 6 mm to about 40 mm.

9. The strut as defined in claim 1 wherein said piston rod has an enlarged end engaging a lower surface of said spool.

10. The strut as defined in claim 1 wherein said spool is a molded polymeric material such as polyethylene and said lower end cap includes an aperture for receiving a threaded fastener.

11. A damper spring strut comprising:
a cylindrical housing having an inner cylindrical surface;
a first end cap mounted to one end of said cylinder and including an aperture therethrough through which there extends a threaded fastener for securing said end cap to an object;
a piston assembly mounted within said cylinder, including a spool supporting an annular friction element for engaging said inner surface of said cylindrical housing, said spool including a central aperture;
a support rod extending through said central aperture of said spool and having an enlarged end extending over an outer surface of said spool facing said first end cap;
a compression spring extending between a surface of said spool opposite said first end cap and extending upwardly in annular concentric relationship with said rod; and
a second end cap mounted to an opposite end of said cylindrical housing and including an aperture through which said rod extends, such that said threaded fastener and said rod can be mounted to support objects for compressing said spring.

12. The strut as defined in claim 11 and further including a cylindrical spring stop surrounding said rod and extending into the annular space between said rod and said compression spring.

13. The strut as defined in claim 12 and further including a lubricant extending between said friction element and said inner surface of said cylindrical housing.

14. The strut as defined in claim 13 wherein said spool is made of a polymeric material.

15. The strut as defined in claim 14 wherein said friction element is made from a closed-cell foam polymeric material.

16. The strut as defined in claim 15 wherein said foam polymeric material is polyurethane.

17. The strut as defined in claim 16 wherein said cylindrical housing is made of steel.

18. The strut as defined in claim 17 wherein said friction element has a height of from about 10 mm to about 40 mm.

19. A damper spring strut comprising:
a cylindrical housing having an end cap at one end thereof;
a piston assembly, including a spool having a central aperture and an annular recess for receiving an annular friction element;
a rod extending through said central aperture in said spool and including an enlarged end engaging a first surface of said spool adjacent said end cap;
a second end cap on an end of said cylindrical housing opposite said first end cap; and
a compression spring engaging a surface of said spool opposite said first surface and extending to said second end cap which includes an aperture allowing said rod to extend therethrough.

20. The damper spring as defined in claim 19 and further including a cylindrical spring stop surrounding said rod and extending into the annular space between said rod and said compression spring.

21. The damper spring as defined in claim 20 wherein said second end cap has a hemispherical outer surface.

22. The strut as defined in claim 19 and further including a lubricant extending between said friction element and said inner surface of said cylindrical housing.

23. The strut as defined in claim 22 wherein said spool is made of a polymeric material.

24. The strut as defined in claim 23 wherein said friction element is made from a closed-cell foam polymeric material.

25. The strut as defined in claim 24 wherein said foam polymeric material is polyurethane.

26. The strut as defined in claim 25 wherein said cylindrical housing is made of steel.

27. The strut as defined in claim 26 wherein said friction element has a height of from about 10 mm to about 40 mm.
